(19) United States
(12) Patent Application Publication
(10) Pub. No.: US 2016/0210268 A1
(43) Pub. Date: Jul. 21, 2016

(54) METHODS AND SYSTEMS FOR MANAGING VISUAL TEXT OBJECTS USING AN OUTLINE-LIKE LAYOUT

(71) Applicant: Mark Allen Sales, Berkeley, CA (US)

(72) Inventor: Mark Allen Sales, Berkeley, CA (US)

(21) Appl. No.: 14/598,194

(22) Filed: Jan. 15, 2015

(51) Int. Cl. G06F 17/21; G06F 3/0481; G06F 17/24; G06F 3/0484; G06F 3/0486

(52) U.S. Cl. CPC G06F 17/212; G06F 3/04845; G06F 3/0486; G06F 3/04842; G06F 17/24; G06F 3/04812

(57) ABSTRACT

We describe methods and systems for managing visual objects within an interactive visual interface controlled by a digital computation device. More specifically, the visual objects include text and are arranged in outline-like hierarchies. In broad terms, this invention makes it easier to interchange content among traditional documents, relational brainstorms, and chat dialogs. To accomplish this, we integrate unique combinations of user interface motifs. Some embodiments involve integrating multi-line text editing into an outlining environment. Some embodiments focus on motifs involving a draggable handle in an outline. Some embodiments focus on multi-panel outlines. Some embodiments focus on creating links that can be traversed in both directions. Some embodiments focus on detecting related or redundant content while the user is brainstorming or composing text. These motifs are integrated in various combinations to create interfaces that are more useful than when implemented in separate applications.

### CROSS REFERENCE TO RELATED APPLICATIONS

This application claims the benefit of U.S. Provisional Patent Application No. 61/927,887 filed Jan. 15, 2014, which is hereby incorporated by reference herein in its entirety.

### TECHNICAL FIELD

The disclosed subject matter relates to methods and systems for managing visual objects within an interactive visual interface controlled by a digital computation device. More specifically, the visual objects include text and are arranged in outline-like hierarchies.

### BACKGROUND

Broadly, the invention offers a user interface for integrating brainstorming, content editing and discussion. To share our way of thinking about this work, we define and differentiate three types of software interfaces based on how their core functions organize data. We define “brainstorming” interfaces as organizing data relationally, “content” editors as organizing data sequentially, and “chat” programs as organizing data conversationally, like a stream-of-consciousness. We argue that the utility of these tools depends greatly on the users' ability to go back and forth effortlessly between these three methods of interfacing with their thoughts.

Developing a good user interface is hard. Often, polished interfaces emerge only after many iterations based on feedback from people using the interface for a specific purpose [Shneiderman et al. 2009]. This process arguably rewards more specialized user interfaces for different tasks. For instance, there are fairly distinct user interfaces for outliners, text editors, mind maps, and chat programs. However, we argue that getting the most out of these programs frequently requires moving a lot of data back and forth between the different programs. When this happens, the individual user interfaces might each be quite polished, but the overall experience is awkward and inefficient. The present work rethinks the way we build a user interface around brainstorming, content creation, and discussion. We describe key characteristics of an interface for elegantly integrating these processes together.

We are concerned with three groups of prior software interfaces. In the first group, tools enable brainstorming and organization of ideas. These tools provide a way to connect different ideas in a relational way. For instance, Mind Maps [Mind Maps n.d.] allow users to organize ideas into a tree-like structure on a two-dimensional canvas. “TheBrain” [TheBrain n.d.] allows more diverse types of connections between ideas, like a semantic network. The focus of these tools is the ways related ideas are connected to each other. We call the data created by these tools “relational brainstorms.”

In the second group, tools enable the creation of structured content. These tools require information to be organized into a sequence. Sections of content might be temporarily collapsed or hidden, but the content retains its sequence. Examples include text editors, word processors, presentation builders, planners and outliners. We call the objects created by these tools “sequential content.” There are many advantages to organizing data this way. We communicate with others sequentially. Videos, written publications and presentations are sequential. We execute plans sequentially. Arranging ideas into a sequential document can also polish the author's understanding. Sequential content is generally well suited for execution and for sharing information.

The processes that generate relational brainstorms and sequential content are heavily codependent. For instance, brainstorming often motivates original sequential content. Reading content can spur new brainstorms. When content has issues, brainstorming is needed. When brainstorming becomes too ungrounded, the ideas need to be grouped and prioritized, organizing them like sequenced content. We therefore suggest that a good user interface must integrate both methods of organizing ideas.

In the third group of software interfaces, tools enable online chat or conversations. Examples include IRC, SMS, Twitter and Skype. These tools support sequential conversations. However, unlike sequenced content, a conversation is not revisable; it is more like a history. Conversations can be thought of as a stream-of-consciousness involving multiple people. Whether used by multiple people, or just one person, the process of capturing a stream-of-consciousness is integral to brainstorming. Brainstorming tools (as we use the term above) organize ideas relationally. However, before ideas are related, they are introduced and captured sequentially, in a process resembling a stream-of-consciousness.

Streams-of-consciousness (or conversations) are also strongly codependent with the processes that generate sequential content. A stream-of-consciousness can provide a draft of content. Changes to content can often be associated with conversations. Conversations provide additional context to specific pieces of content, and the content provides context to the conversations. Perhaps most importantly, the integration of conversations and content offers a bridge between formal and informal collaboration. Conversations are not revised; they therefore tend to be casual and spontaneous. Sequenced content that has been heavily revised can be quite polished and formal. Effective collaboration naturally iterates between casual (conversation-like) and formal (content-like) processes. A good user interface should enable this.

We therefore believe that there is much value in the integration of all three of these types of interfaces—relational brainstorming, content editing, and chat. However, we are not aware of any interface that integrates these methods, at least not any better than copying and pasting text between different applications. This is a poor solution, considering how naturally these processes complement one another. Accordingly, it is desirable to provide methods that overcome this and other deficiencies of the prior art.

A known source of prior art is the online tool workflowy.com. This tool integrates many outlining and text-editing features. The tool has also added some features since the January 2014 filing of provisional 61/927,887. In particular, on May 8, 2014 they tweeted a new feature to “drag the bullet to move in Workflowy,” which we previously described in provisional 61/927,887, summary sections 006 and 010. We claim filing priority for this feature.

### BACKGROUND REFERENCES

Stijn Dekeyser and Richard Watson. 2006. Extending Google Docs to Collaborate on Research Papers. The University of Southern Queensland, Australia, Toowoomba, Queensland, AU, 23 (2008).
Douglas C. Engelbart. 1962. Augmenting Human Intellect: A Conceptual Framework. In Multimedia. From Wagner to Virtual Reality, Randall Packer and Kenneth Jordan, WW Norton & Company, New York, N.Y., 64-90. http://sloan.stanford.edu/mousesite/EngelbartPapers/B5_F18_ConceptFrameworklnd.html
Deniz Eseryel, Radha Ganesan and Gerald S. Edmonds. 2002. Review of computer-supported collaborative work systems. Educational Technology & Society. 5, 4 (2002).
Mind Mapping: List of concept-mapping and mind-mapping software. n.d. In Wikipedia. Retrieved Jan. 12, 2014, from http://en.wikipedia.org/wiki/List_of_concept-_and mind-mapping_software
Outliner [including a feature table for many desktop and online outliners]. n.d. In Wikipedia, Retrieved Jan. 12, 2014, from http://en.wikipedia.org/wiki/Outliner
Ben Shneiderman, Catherine Plaisant, Maxine Cohen and Steven Jacobs. 2009. Designing the User Interface: Strategies for Effective Human-Computer Interaction (5th Edition). Addison-Wesley Longman Publishing, Boston, Mass. DOI: http://dx.doi.org/10.1145/25065.950626
TheBrain: Mind Mapping Software, Brainstorming, GTD and Knowledgebase Software. n.d. Retrieved Jan. 12, 2014 from http://thebrain.com
Workflowy, Organize Your Brain. n.d. Retrieved Jan. 12, 2014 from http://workflowy.com

### SUMMARY

In broad terms, this invention is making it easier to interchange content among traditional documents, relational brainstorms, and chat dialogs. To accomplish this, we focus on several user interface motifs that bridge these domains. Some of the motifs we present involve the integration of text-editing features with outlining features. A hybrid between an outliner and a text-editor provides a preliminary foundation for integrating documents and relational maps. There are existing examples of outliners which behave like text editors (e.g. workflowy.com), so this is not claimed as novel. Critical additions are described that make this synthesis useful and novel. In particular, we focus on adjacent (or nearly adjacent) panels where each panel can each contain an integrated outliner or chat room. Also, in order to prevent outliner operations from interfering with text-editor operations, the outliner's visual real-estate must be used very efficiently and intuitively. Accordingly, we also focus on a user-interface widget that combines two or three outliner capabilities into one intuitive and non-invasive visual object. User interfaces need to help the user navigate content in many directions, so we also focus on navigate between content in a bi-directional relational way. Finally, it is very easy to overlook related content and produce redundant content without realizing it, and so we also focus on integrating the detection of redundant and closely related content into the interface.

In this summary and the following figures, we itemize methods and systems for managing visual objects in a visual interface using an outline-like layout. We summarize not only the key methods and systems that we innovate, but we also describe others that help flesh out the invention to make it practical and useful. These methods and systems have many embodiments. Embodiments utilize and extend prior art. In particular, the invented methods and systems assume prior art for generating interactive images from digital instructions. Many digital electronic devices fulfill this role. The invented methods and systems leverage the ability of such devices to receive commands from the user via an input device, to process these commands according to a set of digital instructions, to access digital storage, and to present updated images to the user. Our methods and systems require that the interactive image can be controlled by digital instructions via a programming language, and the digital instructions can access the user's input actions and digital storage. Examples include web browsers and mobile devices. The invention provides methods and systems for digital instructions to manage the layout and user-interaction of visual objects in this context of prior art.

The following list itemizes features that the invented interface can include. Different embodiments can use different combinations of the itemized features. Some features only make sense when other features are also present. When this is the case, the text of the dependent feature is preceded by one or more numbers in parentheses. That is, the parenthetical numbers itemize the dependencies of each feature. Embodiments of the invention that contain a feature with dependencies must also contain all its dependent features. Some features have multiple parts or capabilities. In this case, the parts or capabilities are listed in the feature description, and some embodiments can contain some parts without others. In some cases, a feature mentions related features in the text. Related features are not necessarily dependencies for the feature.

001. The visual interface can present visual objects in one or more outline-like hierarchies. Visual objects in an outline-like hierarchy are called “visual nodes.”
002. (001) An outline-like hierarchy in the visual interface can be a sub-tree of a unique data outline. The data outline is a tree-like data structure, consisting of data nodes. Visual nodes are visual objects within an outline-like hierarchy that have a corresponding data node in the hierarchy's data outline. The visual outline-like hierarchy displays visual nodes which correspond to data nodes that are descendents of a particular node in the data outline. We call this particular node the hierarchy's “viewport.” Different viewports can show different parts of the data outline. Different viewports can also include some of the same data nodes from the data outline. That is, a data node in the data outline can be represented by a visual node in more than one hierarchy in the interface. When this happens, changes to a visual node in one outline-like hierarchy can be reflected in any corresponding visual nodes in the other outline-like hierarchies. (See FIG. 1)
003. (001) Each visual node can contain an “expand/collapse button” that can be touched or clicked to show (expand) or hide (collapse) the children of the visual node in the interface. The button can be displayed differently depending on whether the visual node is currently collapsed or expanded.
004. (001) Each visual node can contain a “drag handle” that can be dragged to move or copy the visual node to a new location in the data outline. The destination can be within the same visual outline or in another one.
005. (001, 002) Each visual node can contain a “viewport button” that changes the viewport of the current hierarchy to the node where the button was pressed. That is, the only visual nodes then visible in the hierarchy are those which correspond to nodes in the data outline, descended from the activated node. This change is often called “hoisting.”
006. (001, 002, 004, 005) Within each visual node, the same visual object can be used as a “drag handle” that is used as the “viewport button.” The same visual object can cause one effect when tapped or clicked, and another effect when dragged.
006a. (001, 002, 003, 004) Within each visual node, the same visual object can be used as a “drag handle” that is used as an “expand/collapse button.” The same visual object can cause one effect when tapped or clicked, and another effect when dragged.
007. (001, 002, 003, 004, 005, 006, 006a) A single visual object in each visual node can serve as an “expand/collapse button,” a “drag handle” and a “viewport button.” For instance, a single touch or click can cause the object to function as an “expand/collapse button,” a double touch or click can be used to trigger the “viewport button” and dragging the object can cause it to act as a “drag handle.”
008. (001) A visual node can include editable text. A text cursor can be positioned by touching or clicking the text, which permits the input of new text.
009. (001, 008) A hierarchy of visual nodes containing text can be arranged to resemble a text outline. The text of child nodes can be shown indented to the right underneath the text of each parent node.
010. (001, 008, 009) For each hierarchy of visual nodes, the user can interact with the outline of text (008) in a way that is similar to as if the text were inside a text editor. In particular, when editing text, vertically adjacent visual nodes can behave like lines in a text editor, even when the visual nodes do not share the same parent node. This can include some combination of features (011-017).
011. (001, 008, 009) When a text cursor is available, arrow keys can be used to move the cursor up and down in the outline, as well as left and right in the same line. Depending on the structure of the outline, this can move the cursor into a visual node with a different parent than the current visual node.
012. (001, 008, 009) When the text cursor is available at the beginning of the text in a node, pressing the spacebar can increase the indentation of the visual node, adjusting its parent node accordingly. Similarly, pressing backspace can decrease its indentation, adjusting the parent node accordingly. In these cases, the visual node is moved in the visual outline. Its parent node is changed to be the nearest visual node above the current visual node that is one level of indentation less than the current node. The same operations can also be implemented with the tab and shift-tab key combinations.
013. (001, 008, 009) The enter and backspace keys can be used to split or merge nodes like lines, in keeping with a text editor. That is, if a text cursor is available in the middle of a visual node's text, pressing enter will create a new visual node immediately below the current visual node and with the same parent. The text that was to the right of the cursor is moved into the new visual node. If there is no text to the right of the cursor, a new visual node is created with no text. The cursor is then placed at the beginning of the new visual node's text. Alternatively, if the text cursor is at the beginning of the line, pressing backspace can delete the current visual node and merge the text onto the end of the previous node. The cursor is then placed in the previous visual node at the beginning of the newly appended text. In the case where both features (012) and (013) are implemented, this merging action in (013) only works after the visual node has been outdented as far as possible.
014. (001, 008) A mouse or touch can be dragged to select text within a visual node. The selected text is highlighted, similar to a text editor.
015. (001, 008, 014) Double clicking or tapping a word in a visual node's text (008) can cause it to be selected, just as though the cursor had been dragged from one side of the word to the other. Optionally, triple clicking or triple tapping can select all the text in the visual node.
016. (001, 008, 009, 014) If the mouse or touch starts dragging from text in a visual node, and the cursor is dragged outside the node, multiple visual nodes can be simultaneously selected.
017. (001, 008, 014) Clipboard operations such as copy, cut and paste can be available for selected text. When cutting and pasting text from multiple nodes (016), the nodes containing the text can be removed or inserted.
018. (001, 002, 008) For each object hierarchy with a viewport (002), breadcrumbs can be displayed to indicate the location of the viewport node in the data outline. Breadcrumbs list the chain of ancestors from the data outline's root node (on the left) to the viewport node (on the right). The text content (008) of each breadcrumb node is displayed in sequence to represent each node.
019. (001) Part of the visual interface can be partitioned into panels.
019a. (001, 019) Panels can be arranged in a horizontal list.
020. (001, 019) Each panel can contain a unique object hierarchy.
021. (001, 002, 008, 018, 019, 020) A panel with a unique object hierarchy (020), where the object hierarchy has a viewport (002), can have breadcrumbs displayed in the same panel above the object hierarchy.
022. (001) Moving a visual node from one location to another can be accomplished by a single drag action. If visual nodes are in a viewport (002), visual nodes can also be moved between viewports with a single drag action, placing the corresponding node elsewhere in a data outline. The ability to rearrange nodes easily is important for usability. This feature can be implemented using some combination of features (023-027).
023. (001) Dragging an object such as a drag handle (004) can change the interface into a different mode called “drag mode.” In drag mode, the visual interface adjusts to display visual objects that can help identify available locations to drop the dragged object. Examples of such visual objects include 024, 025, 027 and 033.
024. (001, 004, 008, 009, 023) In drag mode, horizontal lines can be used to identify drop locations between visual nodes in the same outline. They can also appear in each outline above the top visual node and below the bottom one. Dropping an object onto one of these lines can move the node to a new location, so that the visual node appears between the two visual nodes adjacent to the horizontal drop line (immediately above and below the horizontal drop line). If the adjacent visual nodes have the same indentation, the dragged node is moved into the text outline (009) with the same parent as these two visual nodes. If the adjacent visual nodes have different indentations, the dragged visual node can be inserted with the same parent as the adjacent visual node with the greater indentation.
025. (001, 004, 023) In drag mode, a visual object such as an arrow can be shown to identify a location where the user can “drop into” an available visual node. Unlike horizontal lines (024) which mark locations between visual nodes, the “drop into” object marks a location that can move the dragged object to be a child of the target visual node. For instance, when an object is dropped on the “drop into” marker, the interface can move the visual node to be the last child of the “drop into” marker's visual node.
026. (001, 004, 023, 025) The “drop into” object (025) can appear in the same location as the drag handle (004) in each visual node. This does not conflict with the use of the drag handle because the “drop into” object appears only in drag mode (023). This can also be done when the drag handle serves multiple purposes, e.g. in (007).
027. (001, 004, 019, 019a, 020, 023) In drag mode, a vertical line can be shown between adjacent panels (019). A line can also be displayed to the left of the leftmost panel, and to the right of the rightmost panel. When a visual node is dropped onto one of these lines, a new panel can be opened at the corresponding location. Any panels to the right of the vertical line can slide further right to make room for the new panel. When a visual node is dropped on a vertical drop line (unlike “drop into” markers (025) and horizontal drop lines (024)) the original dragged visual node is not modified. If the dragged object comes from a viewport (002), the created panel can use the dragged object to determine its viewport and breadcrumbs (021). For instance, suppose a visual node is dragged with a drag handle (004) from a panel with a viewport and a data outline (002). When that visual node is dropped on a vertical line, it can create a panel (019) with the same data outline, but use the dragged node as a viewport.
028. (001) A visual node in a hierarchy can contain a reference to another visual node. This kind of reference is called a link. If the visual node has a viewport (002) then the reference can be to the corresponding node in the data outline.
029. (001, 008, 028) One or more links (028) can be displayed in a text node (008) by appending their referenced nodes' text at the end of the current visual node's text. The referenced nodes' text can be formatted differently to distinguish it from the main node's editable text. If a referenced node has a long editable text, it can be truncated or abbreviated when appending it.
030. (001, 028) The number of links that reference a visual node can be displayed inside the visual node. This is called a “backlink indicator.”
031. (001, 028) A visual node can be dragged “as a link.” When dragging as a link, the original visual node is never moved, unlike when dragging using a drag handle (004). The interface enters drag-mode (023) like when dragging a visual node, and some or all of the same drop objects can be available (024, 025, 027 and 033).
032. (001, 028) Adding a link that references a visual node can be accomplished by a single drag action. If visual nodes are in a viewport, nodes can also be linked between viewports with a single drag action, creating a link between nodes in a data outline. The ability to crosslink nodes easily is important for usability. This ability can include a combination of features (033, 035, 037, 039 and 041).
033. (001, 023, 028) In drop mode, each visual can contain a “link drop.” Dropping an object onto the link drop adds the object as a link (028) to the link drop's visual node. If the visual nodes are text nodes (008), then the link drop can add the reference as a text link (029).
034. (001, 023, 028, 030, 033) The link drop (033) can be positioned in each visual node at the same place as the backlink indicator (030). These two uses for the same space do not create a conflict because link drops only appear in drag mode (023).
035. (001, 023, 028, 031) Each visual node can contain a “link handle” that allows it to be dragged “as a link” (031). Dragging the link handle enters drag mode (023).
036. (001, 023, 028, 030, 035) The same visual object can be used as a backlink indicator (030) and as a link handle (035).
037. (001, 008, 028, 031) Dragging a text link (029) by mouse or touch has the effect of dragging the link's reference node as a link (031).
038. (001, 002, 019, 020, 028) Links (028) can have an operation called “link opening.” A click, tap, double click or double tap can trigger link opening. “Link opening” can open a panel with a unique hierarchy (020) that uses the link's node as a viewport (002). In some cases, if a panel (020) has already been opened by another link opening, the operation can update the viewport of the previously created panel instead of creating a new panel. This update process can be useful for rapidly scanning the contents of a list of links. Reusing the same panel, instead of opening a new panel each time, reduces clutter when rapidly opening multiple links. Panels that can be quickly updated in this fashion can be displayed differently to illustrate their volatile viewport. These panels can also contain a button to transform them into an ordinary panel, which will protect the panel from having its viewport changed by future link opening operations. These panels can also have a graphical effect that visually connects them to the link that opened them. For instance, the visual interface could display a line or arrow that connects the panel to the link that opened it.
039. (001, 002, 008, 018, 028, 029) Breadcrumbs (018) can act as text links (029), inheriting consistent operations when clicked, touched or dragged.
040. (001, 002) A data outline can contain special kinds of nodes called “docked links.” Docked links are nodes in a data outline (002) that reference a different node in the data outline, analogous to a symbolic link in a file system. Docked links can be presented similar to a visual node in a viewport (002).
041. (001, 002, 028, 031, 040) Docked links can be created when a visual node is dragged as a link (031). For instance, if a dragged link is dropped onto a horizontal line (024) or onto a “drop into” object (025), then a docked link can be created. A docked link (040) is inserted at the same location that the original node would have been moved had the user been dragging a drag handle (004) instead of a link. The docked link references the same node as the dragged link that created it. For example, if a user drops a link onto a “drop into” object, the interface can insert a docked link as the last child of the “drop into” target node.
042. (001, 002, 008, 009, 018, 039, 041) When a docked link (041) is displayed as a visual node in a text outline (009), the visual node can include breadcrumbs (018) that display the ancestry of the docked link's reference node. The breadcrumbs can be displayed above the visual node's editable text (008). If the visual node has an expand/collapse button (003) the breadcrumbs can be hidden when the visual node is collapsed.
043 (001, 002, 019, 020, 028, 038, 040) Docked links can have a button that opens a new panel like the “link opening” operation for links (038). This button can optionally replace the viewport button (005) that would appear in a regular visual node. For instance, in an integrated handle (007), double clicking the handle could perform this operation and open a panel. If a docked link (040) is collapsed (003), clicking on the docked link's editable text (008) can execute the link open (038).
044. (001, 023) In drag mode (023), drop objects (like 024, 025, 027 and 033) that are not logically available can be hidden, to prevent the user from trying to drop a visual node onto an unavailable target. This feature can be used to prevent logical inconsistencies, such as dropping a visual node inside itself, or dropping a visual node inside of another visual node that corresponds to the same node in the data outline (002).
045. (001, 008, 028, 029) When a text link (029) is touched or clicked, it can open a popup that contains more information about the link. The popup can contain the referenced node's breadcrumbs (018) and editable text (008). The popup can contain arrow buttons that move the text link to the left or right relative to other text links in the same visual node. The popup can also contain a button to remove the text link from the visual node.
046. (001, 002, 003) When a visual node is expanded or collapsed (003) this state can be stored by the system for future reference. The state of the visual node (whether it is expanded or collapsed) can be stored in the corresponding node in the data outline (002). This permits the state to be restored when the node becomes visible in another hierarchy. The state of the visual node can also be stored specific to the visual node's hierarchy (001). This allows different hierarchies to be expanded or collapsed in different ways, even when they contain some of the same nodes from the data outline. If different hierarchies display the same node in different states, the most recent change can define the node's status in the data outline. The node's status in the data outline can be referenced to decide how to display the node in a new hierarchy. The retention of the status of visual nodes allows outlines to be grouped into “pages” that can be expanded or collapsed together.
047. (001, 004, 019, 019a, 020, 023, 027) Each panel can contain a “panel handle” that can be dragged to move the panel to a new location. Dragging a panel behaves similar to dragging a visual node (004), and activates drag mode (023). However, unlike when dragging a visual node (004), vertical lines (027) can be the only drop targets displayed in drag mode. Dropping the panel onto one of these vertical lines rearranges the panels accordingly. Any panels to the right of the vertical line slide further right to make room for the new panel.
048. (001, 019) Each panel (019) can contain a button that removes it from the interface. If the panel is in a horizontal sequence (019a) then it is removed from this sequence.
049. (001, 002, 008, 018, 019, 020, 021, 028, 029, 039) Panels with breadcrumbs (021) have the editable text (008) of the viewport node (002) as the last breadcrumb. This breadcrumb is called the “panel title,” and it can function differently than the preceding breadcrumbs. The title can also be displayed in a different format than other breadcrumbs. As an example, when clicking on the panel title, the text can be treated like editable text (008) instead of functioning like a breadcrumb link (039).
050. (001, 019, 019a) The panels (019a) can slide one panel to the left or right when horizontally “swiped.” This is useful, for instance, to navigate between panels on a touch screen.
051. (001, 019) Panels (019) can each be independently scrolled up and down. The method of scrolling depends on the embodiment. Sometimes, each panel can be scrolled by dragging an area inside the panel up or down. In some cases, a panel can be scrolled by dragging a scroll bar on the side of the panel.
052. (001, 019, 023, 051) Panel scrolling (051) can behave differently in drag mode (023). In drag mode, dragging the object close to the top or bottom of a panel can cause the panel to scroll.
053. (001, 002) Undo and redo buttons permit stepping through the user's history of actions. Two types of actions can be distinguished. One type of action updates the data outline. A second type updates the visual presentation of the data outline. Both types of actions can be stored in the user's history and stepped through with undo/redo. Actions that update the data outline can also be visible to other users that are editing the same data outline.
054. (001, 002) When stepping through the history using the undo/redo buttons, helper animations can be shown to help the user identify the change. For example, visual nodes that move from one location to another can be animated to move accordingly.
055. (001) A “zoom button” can be available in the interface. The zoom button can toggle between two different magnification levels. A plus button can be used to zoom in and a minus button can be used to zoom out. The zoomed-in state can be more appropriate for editing, while the zoomed-out state can make text scanning easier. This is particularly relevant for touch screen embodiments. In this case, the text is easier to edit when the text (008) and drag handle (004) are about the size of a finger, but it is easier to scan when they are smaller.
056. (001, 019) The width of panels visible on the screen at once and the font-size can automatically adapt to the size and form-factor of the viewing device. Other visual objects in the interface can also be scaled accordingly.
057. (001, 002, 004, 023) An “inbox” visual object can be a target for dropping visual nodes in drag mode (023). Dropping a visual node into this marker moves its node in the data outline (002) to a special inbox location in the data outline. The inbox visual object can also be opened like a link (038), which opens a new panel with the viewport defined by its reference node (the inbox location in the data outline).
058. (001, 023) A “trash” visual object can be a target for dropping visual nodes in drag mode (023). Dragging a visual node onto the “trash” object deletes the visual node.
059. (001) Animated transitions can be shown when docking a visual node into a new location, creating or deleting visual nodes, opening a panel or other operations. Whenever the interfaces changes in a rapid “jump” that could be confusing for the user, an animation can be added that illustrates the change that is happening. For instance, when changing the viewport of a panel, the visual node's text can move smoothly to the position of the panel title.
060. (001, 008) Text nodes (008) can contain a URL, an image, or an attached file. URL's can be pasted or dragged from other locations. Images or files can be added through the filesystem or dragged from another location. Thumbnails can be automatically generated to represent an image or file.
061. (001, 008) Editable text (008) can include rich text, such as boldface or italics.
062. (001, 002, 008) The data outline can be automatically imported from a file or exported to a file. The editable text (including url's) can be imported or exported as a simple text file with line indentation matching the data outline. When importing or exporting a simple text file, text links can optionally be included. Links can, for instance, be represented as the line number of their referenced nodes in the output file.
063. (001, 002) A search area can be displayed in order to give the user the ability to perform text searches and to display search results. This search area can be presented inside a panel (019). In this case, the panel is called a search panel. The search area contains an area for the user to enter “search text”, and an area for matching results to be displayed as “search results.” Search results are chosen from the data outline based on the search text entered. Search results can be grouped by their location in the data outline. For instance, search results with the same parent can be grouped together under a breadcrumb (018) that designates their common parent. Search results can be displayed as collapsed docked links (040). Search results can be dragged like a link (037) and opened like a link (038).
064 (001, 002, 019, 063) A search button can be persistently visible in the visual interface. Pressing the search button can open a search panel (063).
064a. (001, 002) Contextual matches can by found by searching for nodes or lists of nodes that have similar text to nodes in a currently visible panel. Contextual matches can help identify similar content, and can also help users avoid redundant work by making them aware of past work that is very similar to their current work.
065. (001, 064, 064a) When no search text is present in the search panel (063), the interface can still show relevant search results based only on the visible context elsewhere in the interface (064a). If a persistent search button is available (064), this visual real-estate can be reused when there is no search text, in order to display the existence and/or number of matching contextual results. For instance, the button could show a small “2” when there are 2 other outline locations that match the outline's current visual context.
066. (001, 002, 019, 028, 030, 063) Clicking or tapping on a backlink indicator (030) can open a search panel (063), with the search results replaced by the list of visual nodes which have nodes in the data outline that contribute to the count on the backlink indicator (030). These nodes can be presented and grouped like search results (063).
067. (001, 002). A conversation area can be displayed in order to allow the user to communicate more spontaneously about some part of the data outline. This area can be inside a panel (019). In this case, it is called a conversation panel. A conversation area contains an area for displaying past comments and also contains an area for adding a new comment. Past comments can be arranged vertically in reverse chronological order. Each comment can specify the username of the person that posted the comment, the comment or outline node that the comment is addressing, and the text of the comment. A comment can also specify the time and date it was posted. A comment can address either another comment or a node in the data outline. If a comment addresses another comment, the username that posted the addressed comment can be shown. If this username is clicked, the full text of the addressed comment can be shown in a popup window. If the comment instead addresses a node in the data outline, a text link (029) referencing the node can be shown.
068. (001, 002, 067) For each node or panel, a button can be available that creates a new conversation area (067) about a topic node. A conversation started this way has a “topic node.” If a start button is in a node, the new conversation can use that node as its topic node. If a start button is in a panel, the new conversation can use the panel's viewport as its topic node. Alternatively, the conversation can be started by dragging a visual node onto a designated marker elsewhere in the interface. In this case, the dragged node is the conversation's topic node. The first comment in a conversation can address the conversation's topic node (067).
069. (001, 002, 019, 019a, 067) A conversation panel can be visually linked to the panel to its left. This linking can occur when the panel adjacent to the conversation panel contains the conversation's topic node. In this case, the topic node can be visually linked to the conversation panel. This is similar to the way a panel created by a link opening operation (038) can be linked to its creating node, and to how a backlink indicator can connect a node to a search panel (066).
070. (001, 002, 067) Each comment can have a reply button. Clicking this button initiates a new comment that addresses the comment containing the reply button. Alternatively, a visual node can be dragged from another outline into the conversation area. If the visual node is dropped in the conversation area, a comment can be initiated that addresses the dropped node. When a comment is initiated, a text cursor is available to compose a comment. If the user presses a reply button or drags a node onto the conversation after a comment has already been initiated, then the additional node or comment can instead be prepended to the comment as a text link.
071. (001, 002, 067) A conversation area contains an area for posting new comments. This area can show the current user's username. It can also show what the comment is replying to, as specified in (070). It can also show any text the user has typed at the comment text cursor.
072. (001, 002, 067) A conversation area can have a button to invite others to participate in the conversation. Invited users may view the active conversation and the portion of the data outline inside the conversation's topic node. Users can be invited with different options. Depending on options chosen, invited users may optionally be given permission to add comments in the conversation, to edit the shared portion of the data outline and/or to invite other users.
073. (001, 002, 067) Comments that are referenced by other comments can be considered to be in the same thread. At any given time, one thread is considered the active thread. The active thread can be changed by clicking or tapping on a comment. The currently active thread can be visually highlighted to help the user focus on the most relevant comments. Nodes in the data outline that are referenced by comments in this thread can also be highlighted. A mechanism can exist to hide all comments that are not in the active thread. Double tapping or double clicking on a comment in the active thread can serve as this mechanism. When comments are hidden, a button can be made available to restore all comments to the conversation area.
074. (001, 002) The visual interface can be run on a client machine that communicates with a remote server machine. The server machine can relay updates between multiple users who are accessing some of the same nodes in a data outline. This relay can happen in real time to permit concurrent editing.
076. (001, 002) The data outline and history can be stored locally and edited on a machine without a network connection.
077. (001, 002, 074, 076) To avoid conflict between local offline changes and remote online changes, a viewport can be “checked out” making it read-only over the network. Nodes descended from the “checked out” viewport node can be edited offline by the user who checked it out without worrying about remote conflicts.

### BRIEF DESCRIPTION OF THE DRAWINGS

FIG. 1: This figure illustrates many important visual objects visible from within the interface.

FIG. 2: This figure illustrates two of the three capabilities of the node handle. The third capability is drag and drop, which is shown in FIG. 3.

FIG. 3: When a node handle (106) is being dragged by the mouse, this figure shows how the interface is modified. Dashed lines and other visual objects are used to mark possible places to drop the object. Dragging other objects like links (110) and breadcrumbs (104) displays a similar interface. Dragging a panel (130) shows a similar interface, but only with vertical lines (312) shown.

FIG. 4: When a link (110) is clicked, this popup enables the user to interact further with the link.

FIG. 5: This figure shows the interface after pressing the search button (124) and typing text into the search text field (504). It illustrates the visual objects in a search panel (512).

FIG. 6: When the start conversation button (120) is clicked, a new panel (116) opens to hold a conversation about the original panel's viewport node. The original panel's viewport node is considered the initiating node of the conversation panel. The conversation panel can be moved and deleted like other panels.

FIG. 7: This figure shows the process by which a node handle (106) can perform diverse operations.

FIG. 8: This figure shows the process where an editable outline triggers a user notification when the content is similar to other stored outlines.

FIG. 9: This figure shows prior art where multi-line text editor commands can be integrated with an outline interface. Integrating this motif into a broader interface is important for many of the applications we discuss.

FIG. 10: This figure shows prior art where multiple client computers communicate with server over a communications network.

### DETAILED DESCRIPTION

This description is structured to parallel the figures. The figures illustrate particular ways to embody the summarized interface. In order to make the implementation concrete and particular, the interface is described inside of a web browser within a Windows operating system, controlled by a mouse and keyboard. For each figure, a particular combination of features is selected from those summarized. These features are visually arranged in a particular way. Specific methods of interacting through clicks or keystrokes are often chosen. These specifics are all particular to the embodiment described. They provide a particular example of how they invention can be embodied, and should not be taken as implying any constraints on the invented interface.

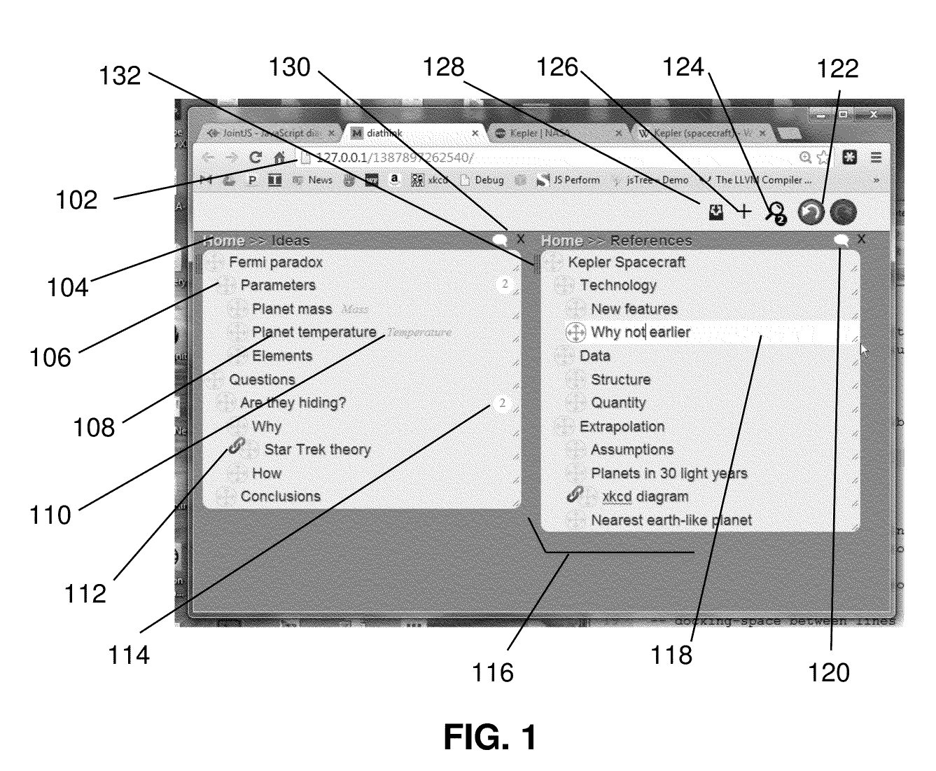

### FIG. 1—Interface Overview

This figure illustrates many important visual objects visible from within the interface. It provides a nice overview of most of the components of the interface. This embodiment also illustrates how many different features can all be integrated into the same interface.

102—Browser Context: This interface is implemented inside of the Chrome web browser running on the Windows 7 operating system. User input is done with a mouse and keyboard.
104—Panel breadcrumbs: Each panel (116) is a viewport for a node in a data outline. That is, it presents a visual outline of a portion of the data outline. The panel breadcrumbs identify the location of the viewport node within the data outline. The first breadcrumb ‘Home’ refers to the root of the data outline. The next breadcrumb “Ideas” is the editable text (108) of a node at the top level of the data outline. Each breadcrumb references a node that is the child of the previous breadcrumb's node. The text of each breadcrumb is the same as the editable text (108) of the node corresponding to the breadcrumb. When the breadcrumbs cannot all fit on one line, they wrap around like ordinary text, pushing down the visual objects below it.

Breadcrumbs can be clicked, double-clicked, dragged, and can have things dropped onto them. Clicking them is like clicking a link (110), which opens a popup (402). Double clicking a breadcrumb replaces the panel's viewport (116) with the breadcrumb's node. For instance, double clicking on ‘Home’ shows the data outline in the corresponding panel. The last breadcrumb, also called the title, is the editable text of the viewport node. Clicking the title permits editing its text, unlike other breadcrumbs. Dragging a breadcrumb behaves like dragging a link (110). Dropping a draggable object onto a breadcrumb acts like dropping it into the drop arrow (306) of the corresponding node.

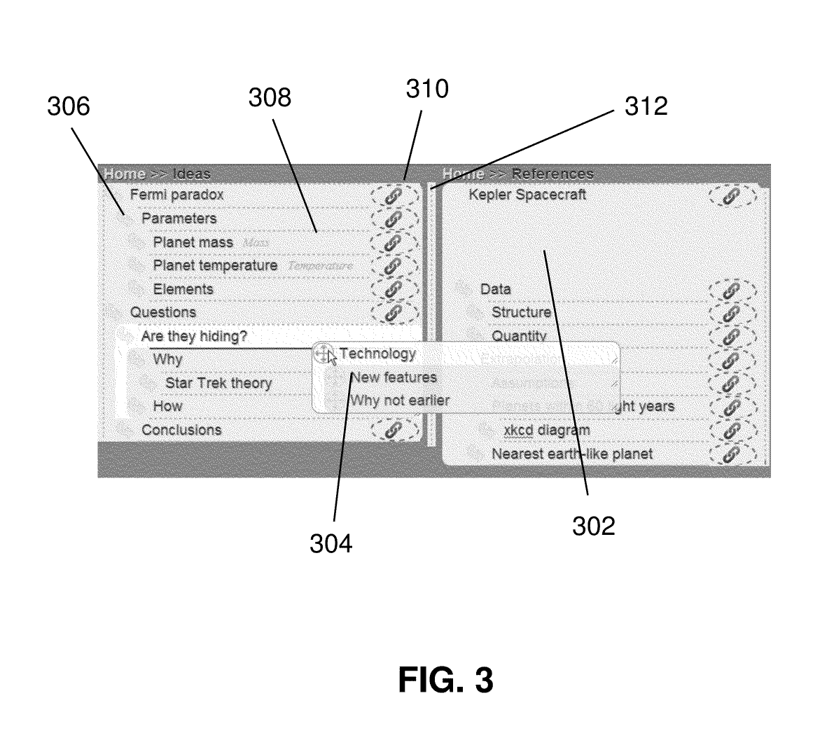

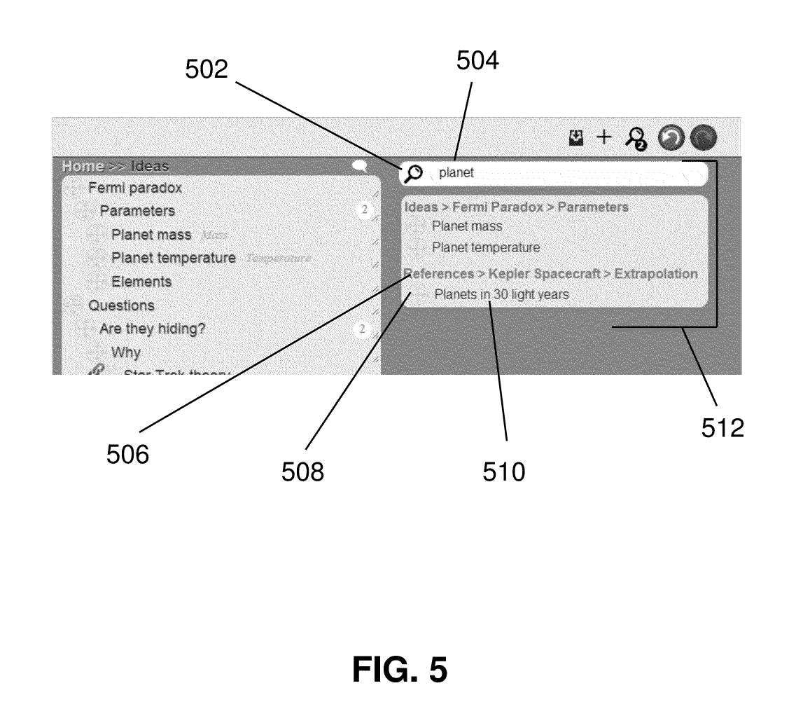

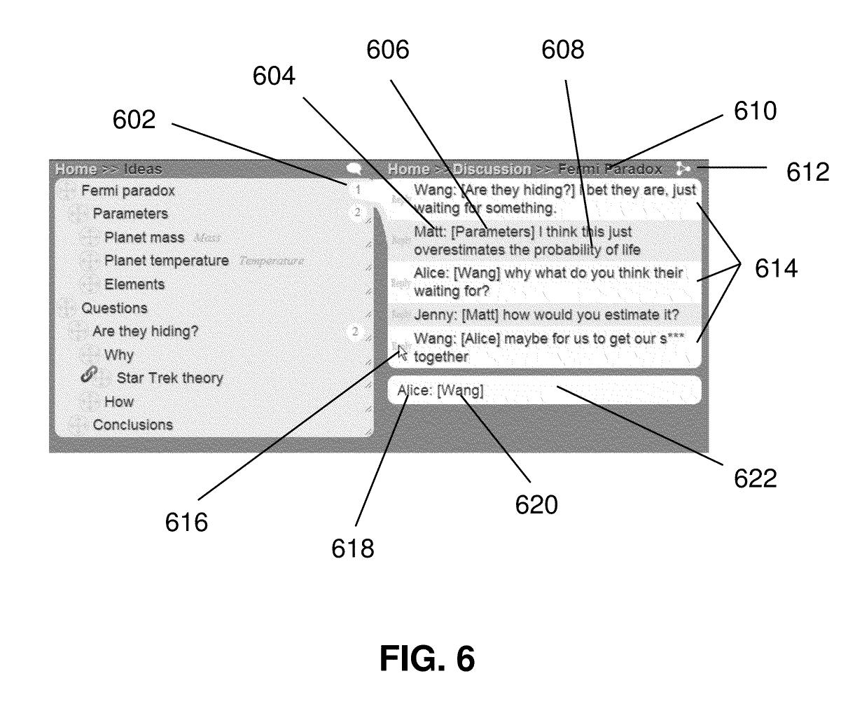

106—Node handle: The node handle is a visual object used for performing operations on the corresponding node. The corresponding node is the node represented by the visual node that contains the handle. The node handle can be clicked, double clicked or dragged. For nodes which contain children, clicking will expand or contract the list of children (202, 203), and double clicking will change the viewport of the active panel to match the node handle's node (204, 205). Dragging the handle allows the node to be moved to a new location in the interface. FIG. 3 shows the different places where a dragged node can be dropped. Unless otherwise specified, dropping the node will move the node to a new location in the data outline. All visual nodes in the interface are then updated to reflect this change.
108—Editable text: Each node in the data outline can contain text. This text is displayed inside the corresponding visual node, and it is editable when clicked. Then, the visual node becomes a focused node (118). If the text in a node does not fit on one line, it wraps around, pushing down any visual objects below it.
110—Link: In addition to text, each node can contain one or more links to other nodes. Each link is a visual object contained in a visual node. The link references a target node elsewhere in the data outline. The links are displayed at the end of the text. If more text is added, the links are pushed to the right and wrapped around, as though they were part of the editable text. The links are formatted differently than text, to indicate they are clickable and draggable objects. Clicking a link opens a link popup (402). Double clicking opens a new panel to the right of the active panel. The new panel uses the link's target as its viewport. Dragging a link makes a copy of the link that can be dropped elsewhere in the interface. Drop locations are described in FIG. 3. Unlike dragging a node handle (106), dragging a link creates a new copy and never moves the original.
112—Docked link. When a link (110) is dragged and dropped onto a horizontal drop line (308) or a drop arrow (306), this creates a docked link. Docked links are a different kind of node in the data outline. They exist in one place in the data outline, and reference a node elsewhere in the data outline. They permit content from remote parts of the data outline to be presented in a different context. The drag handle and text behave mostly like a regular node's handle and text. However, the text and children are those of the referenced node. Changes to the text and children are reflected in the link's referenced location. When expanded, the breadcrumbs of the original location are shown above the object's text. When contracted, clicking in the text does not permit editing. Instead, it opens a temporary panel to the right, using the referenced node's location as a viewport. Double clicking a docked link's drag handle also opens up this panel to the right, instead of replacing the current panel.
114—Backlink indicator: When a node is referenced by other locations in the data outline, the backlink indicator displays the number of such links. Links (110) and docked links (112) that reference this node count toward the total. Also, if a conversation is begun from this node using the Start Conversation button (120), then a different graphical icon is displayed around this number. When clicked, a search panel is opened to the right of the active panel. The search results list each node that references the current node. When the backlink indicator is dragged, the interface behaves the same as when dragging a link (110) that points to the originating node.
116—Panel: Each panel (116) is a viewport for a node in a data outline. That is, it presents a visual outline of a portion of the data outline. Panels can be rearranged (130) and closed (132).
118—Focused node: When a visual node is clicked or newly created it is focused. It is displayed brighter than other nodes. The text can be edited when the node is focused. A simple click inserts a cursor into the text. A double click selects a word. When text is selected, many keystrokes behave analogously to a text editor. The up and down arrows move the cursor to the corresponding node. Tab and shift-tab change the indentation of the node. Backspace outdents the node if possible, or merges with the previous node if not. Pressing return in the middle of the text splits a node into two. Standard text clipboard operations are available.
120—Start conversation: This button opens the conversation panel for this node. The panel is opened to the right of the active panel. The conversation panel is shown in FIG. 6.
122—Undo & Redo: These buttons step through the history of recent changes made by the user. Animations are shown to help remind the user what is being changed at each step.
124—Search with suggestion: This button opens the search panel (FIG. 5). The suggestion number appears when the visible working content is highly similar to content found elsewhere in the data outline, and the other content is not linked or referenced by the working content. This is useful for detecting redundant or related content written previously. The number indicates the number of matches.
126—Zoom: This button toggles between two zoom states. A plus button zooms in and a minus button zooms out. The zoomed-in state is more appropriate for editing, while the zoomed-out state makes scanning easier. This is more relevant for touch-screen applications than for desktop applications.
128—Inbox: The inbox is a persistent visual object that references a special Inbox node in the data outline. Visual nodes can be dragged and dropped onto the inbox to place them in the data outline's inbox. Clicking the inbox opens a panel with the inbox as its viewport.
130—Panel close box: This removes the panel from view. If there are panels to the right of the removed panel, they slide to the left to fill the gap.
132—Panel handle: Panels can be rearranged by dragging this handle. Unlike when dragging nodes, when dragging a panel the vertical drop lines (312) are the only visible drop locations from FIG. 3. Dropping the panel onto one of these vertical lines rearranges the panels accordingly.

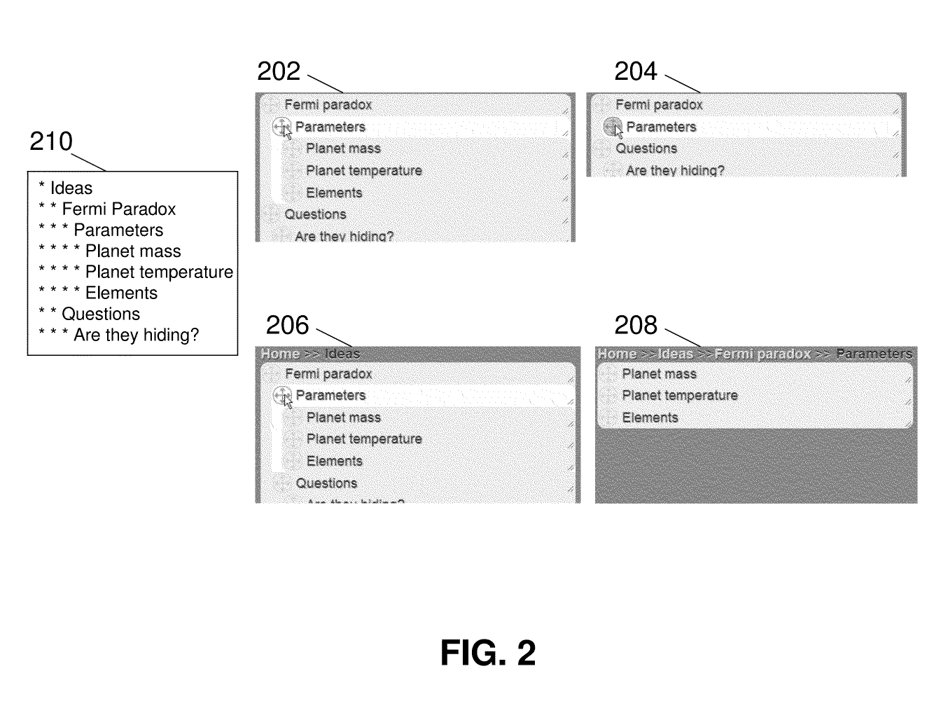

### FIG. 2—Handle Icon Reuse

This figure illustrates two of the three capabilities of the node handle. The third capability is drag and drop, which is shown in FIG. 3. It also illustrates how multiple outline views can share the same data outline.

202, 204—Expanded and contracted nested list: When the node handle (106) is clicked, the children of the node are shown or hidden.
206, 208—Before and after anchoring view: When the node handle (106) is double clicked, the viewport of the active panel is changed to point to the chosen node, also known as hoisting.
210—Data outline: This depicts the data outline used in all four of the screenshots: 202, 204, 206 and 208. Hoisting and toggling the visibility of children are two operations that change the presentation of the visual outline, but these operations do not modify the data outline.

### FIG. 3—Drag Mode

When a node handle (106) is being dragged by the mouse, this figure shows how the interface is modified. Dashed lines and other visual objects are used to mark possible places to drop the object. Dragging other objects like links (110) and breadcrumbs (104) displays a similar interface. Dragging a panel (130) shows a similar interface, but only with vertical lines (312) shown.

302—Drag origin: This is where the dragged item appeared originally before being dragged. The space is preserved until the user releases the object. If the user does not release the object on a valid drop target, the object will return to this origin.
304—Drag object: This visual object includes the selected visual node, including all visible children of the node. It is shown while dragging to remind the user what is about to be moved.
306—Drop arrow: The drop arrow is a visual object that can replace the node handle (106) while the user is dragging an object. Each visual node, except for nodes inside the dragged node, has a drop arrow shown in the same location as where the node handle normally appears. When a node is dropped here, it is moved in the data outline to be the last child of the drop arrow's node.
308—Horizontal drop line: A horizontal dotted line appears between each adjacent pair of visual nodes in the same panel (116). They also appear in each panel above the top visual node and below the bottom one. Dropping a node onto one of these lines moves the node into a new location in the data outline, so that the visual node appears between the two visual nodes adjacent to the horizontal drop line. If the adjacent visual nodes (immediately above and below the horizontal drop line) have the same indentation, the dragged node is moved into the data outline with the same parent as these two nodes. If the adjacent nodes have different indentations, the dragged node is inserted with the same parent as the adjacent node with the greater indentation.
310—Drop link: A drop link is a visual object that can replace the backlink indicator (114) inside each visual node when dragging an object. Unlike horizontal drop lines and drop arrows, when a node is dropped on a drop link the node is never moved from its original location. Instead, a link (110) that references the dragged node is added to the drop link's node.
312—Vertical drop line: When a node is dropped onto one of these lines, a new panel is opened at the corresponding location. Any panels to the right of the vertical line slide further right to make room for the new panel. The panel uses a viewport that is determined by the dropped object. When a node is dropped on a vertical drop line, unlike drop arrows and horizontal drop lines, the original node is never moved in the data outline.

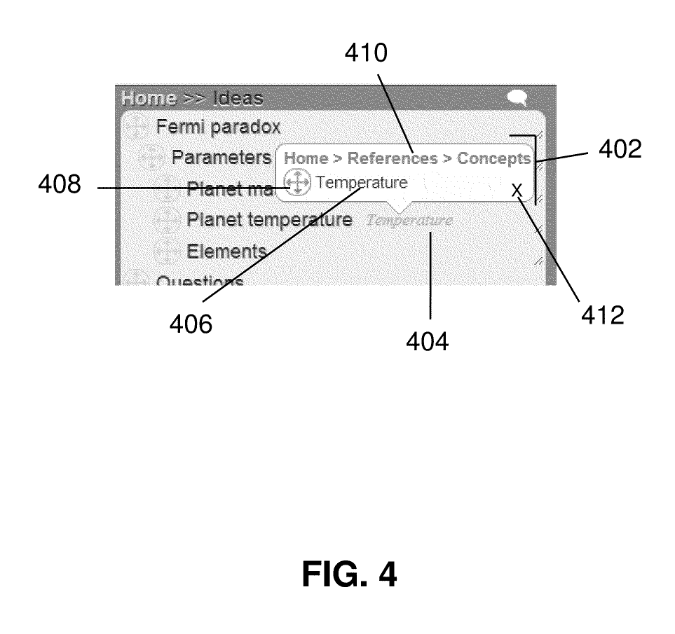

### FIG. 4—Link Popup

When a link (110) is clicked, this popup enables the user to interact further with the link.

402—Link popup: The link popup is a visual object shown when a link (110) is clicked.
404—Open link. An open link is a special case of a link (110). Only one link may be an open link at a time in the interface. Opening a link popup (402) for second link closes the first link popup.
406—Link popup title: This shows the editable text (108) for the node that the open link (404) references. This is normally the same as the text in the link itself.
408—Link popup handle: This behaves the same as the node handle (106) for a docked link (112).
410—Link popup breadcrumbs: These breadcrumbs show the ancestors of the open link's referenced node (404), just as panel breadcrumbs (104) show the ancestors of the panel's viewport node. These breadcrumbs behave the same as same as the breadcrumbs in an expanded docked link (112). Each breadcrumb in the sequence behaves like a link (110) pointing to the node referenced by the breadcrumb. Dragging or double-clicking each breadcrumb behaves accordingly. However, single-clicking one of these breadcrumbs does not do anything, unlike a link.
412—Link Delete: This button will remove the open link (404) from the node that contains it.

### FIG. 5—Search

This figure shows the interface after pressing the search button (124) and typing text into the search text field (504). It illustrates the visual objects in a search panel (512).

502—Search handle: The search handle identifies the panel as a search panel. It may be given other functionalities at a later time.
504—Search text: This visual object is a clickable text field where the user may enter text. If no text is entered here, the search results will only show suggestions based on the current context, matching the count in the search button (124). When text is entered, search results are shown that match this text.
506—Search result breadcrumb: This shows the ancestry of the subsequent visual nodes in the data outline, just as panel breadcrumbs (104) show the ancestry of the panel's viewport node. Clicking or dragging on one of these breadcrumbs behaves the same as interacting with a link (110).
508—Search result handle: This handle behaves like a node handle (106) for a docked link (112).
510—Search result text: This visual node displays the editable text (108) for the matching node. However, the search result text is not editable when the search result handle (508) is collapsed. The text functions like a docked link (112).
512—Search panel: This panel is similar to an ordinary panel (116). Instead of showing a viewport of the data outline, it is designed to show search results. The panel can be rearranged (130) or deleted (132) like other panels.

### FIG. 6—Conversation

When the start conversation button (120) is clicked, a new panel (116) opens to hold a conversation about the original panel's viewport node. The original panel's viewport node is considered the initiating node of the conversation panel. The conversation panel can be moved and deleted like other panels.

602—Conversation anchor: In some cases, the conversation panel is visually linked to the panel to its left. This linking occurs when the panel adjacent to the conversation panel displays the visual node that initiated the conversation. In this case, the initiating visual node may be visually linked to the conversation panel.
604—Comment user: The username of the user who typed each comment is shown at the beginning of that comment.
606—Comment addressing: All comments must address either another comment or a node in the data outline. If the comment addresses another comment, the username of the addressed comment is shown here. If the username is clicked, the full text of the addressed comment is shown in a popup window. If the comment instead addresses a node in the data outline, the node's editable text is shown here.
608—Comment text: This area holds the comment text typed by each user. Clicking on it changes the focused thread (614).
610—Conversation breadcrumbs: These breadcrumbs show the location of the conversation's initiating node in the data outline. The breadcrumbs behave like a regular panel's breadcrumbs (104). However, the graphics surrounding the breadcrumbs appears different than a regular panel (116) in order to identify this panel as a conversation panel.
612—Conversation invitation: This button permits the user to invite others to the conversation. When clicked, a dialog opens offering options for invited users. All invited users may view the active conversation and the portion of the data outline inside the conversation's initiating node. Invited users may optionally be given permission to add comments in the conversation, to edit the shared portion of the data outline and/or to invite other users.
614—Comment in focused thread: If the user has recently posted a comment, this comment is focused. Alternatively, if the user has clicked one of the comments, then the clicked comment is focused. Only one comment can be focused at a time. However, other comments or outline nodes that are referenced by the focused comment are in the focused thread. Inclusion in the focused thread is recursive. That is, it includes comments which are referenced by comments that are referenced by the focused comment. All comments and visual nodes that are in the focused thread are shown more brightly than other nodes. Also, if a comment in the focused thread is double clicked, then all other comments in the conversation panel are temporarily hidden. A “Show All” button then appears at the top of the conversation panel which, when clicked, restores all hidden comments.
616—Reply button: Clicking this button focuses the containing comment and places the text cursor in the reply text input (622). The username in the original comment is shown as the addressing user (620) in the composed comment. Users can address a node outside the conversation panel by dragging a node (e.g. with its node handle) and dropping it anywhere inside the conversation panel. This will have the same effect as pressing the reply button, but with the dragged node's text used in place of the addressing user.
618—Replying User: This shows the username of the user who is currently logged in and interacting with the interface.
620—Addressing user: This shows the username of the author of the comment that the current user is replying to. If the current user is instead addressing a node elsewhere in the data outline, this text can alternatively show this editable text.
622—Reply text input: This is where the current user may type a new comment. When the user presses enter on the keyboard, the comment will be appended to the comments in the conversation panel.

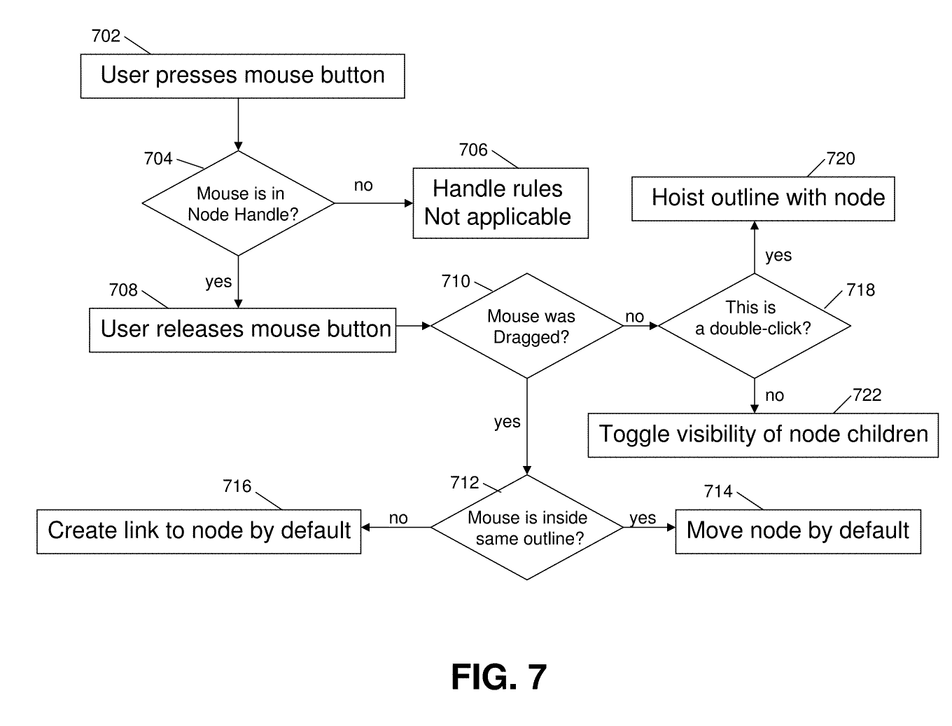

### FIG. 7—Node Handle Process

This figure shows the process by which a node handle (106) can perform diverse operations. This figure characterizes embodiments where many of the possible capabilities of a node handle are all active together at once. Screenshots of the node handle's capabilities were available in FIG. 2 and FIG. 3.

702—User presses mouse button.
704—Mouse is in Node Handle?: The process depends on whether the mouse was pressed on a node handle.
706—Handle rules not applicable: If the mouse was not pressed on a node handle, other processes will handle the action and these rules are not applicable.
708—User releases mouse button.
710—Mouse was dragged?: If the mouse was released roughly where it was pressed, then the handle was pressed like a button. If it was released elsewhere, then it was dragged.
712—Mouse is inside same outline?: If the mouse was dragged, the process depends on whether or not it was dragged to a different outline or not.
714—Move node by default: If the node was dragged to a new location in the same outline, then the node is generally (by default) moved to that location.
716—Create link to node by default: If the node was dragged to a new location in a different outline, then the node is generally (by default) linked at that location.
718—This is a double-click?: If the node handle has been clicked twice in a row, then the process handles this click differently.
720—Hoist outline with node: If the node handle was double-clicked, the node is used to set the viewport of the visual outline.
722—Toggle visibility of node children: If the node handle was single-clicked, then we toggle the visibility of the node's child nodes.

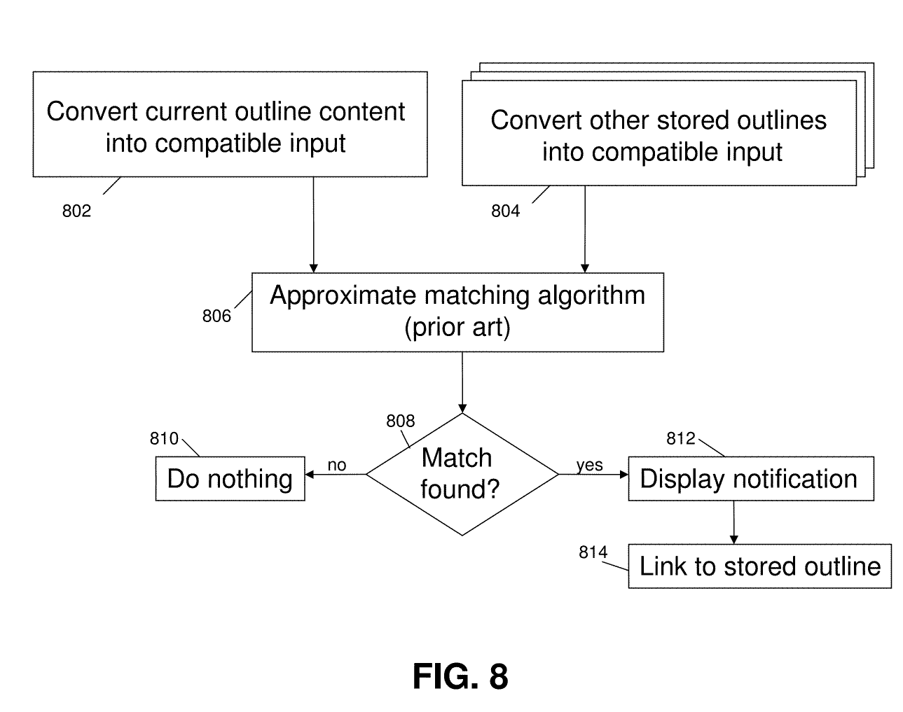

### FIG. 8—Notification of Similar Content

This figure illustrates the process where an editable outline triggers a user notification when the content is similar to other stored outlines.

802—Convert current outline content into compatible input: The current outline (or perhaps only the currently visible pieces of it) are converted into a format where they can be input into an approximate matching algorithm.
804—Convert other stored outlines into compatible input: Other stored outlines have already been converted into a format where they can be utilized by an approximate matching algorithm.
806—Approximate matching algorithm (prior art): These algorithms can fairly quickly find similar content and rate the similarity.
808—Match found?
810—Do nothing (or optionally hide the notification): If no match is found, we could do nothing, or in some cases remove an earlier notification.
812—Display notification: If a match is found, we display a notification to the user. The notification is often displayed in the same area where the user can initiate search (124).
814—Link to stored outline: When the user clicks on the notification, it can open a panel showing the closest match. Alternatively, it can open a panel showing a list of multiple outlines that match the current outline content.

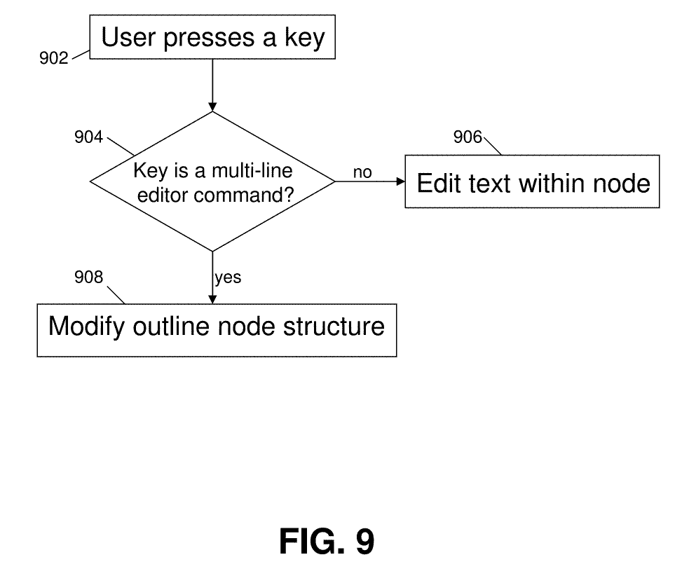

### FIG. 9—Multi-Line Keystroke Handling (Prior Art)

This figure shows prior art where multi-line text editor commands can be integrated with an outline interface. Integrating this motif into a broader interface is important for many of the applications we discuss.

902—User presses a key.
904—Key is a multi-line editor command?: This determines whether or not a conventional text editor can handle the keystroke within a single outline node, or whether the action requires communication with other nodes.
906—Edit text within node: The text within a single node is edited using conventional text editing processes.
908—Modify outline node structure: A custom command is executed which involves multiple outline nodes and often does a mixture of text-editing and outline reconfiguration. For examples of multi-line edit commands, see summary 011-017.

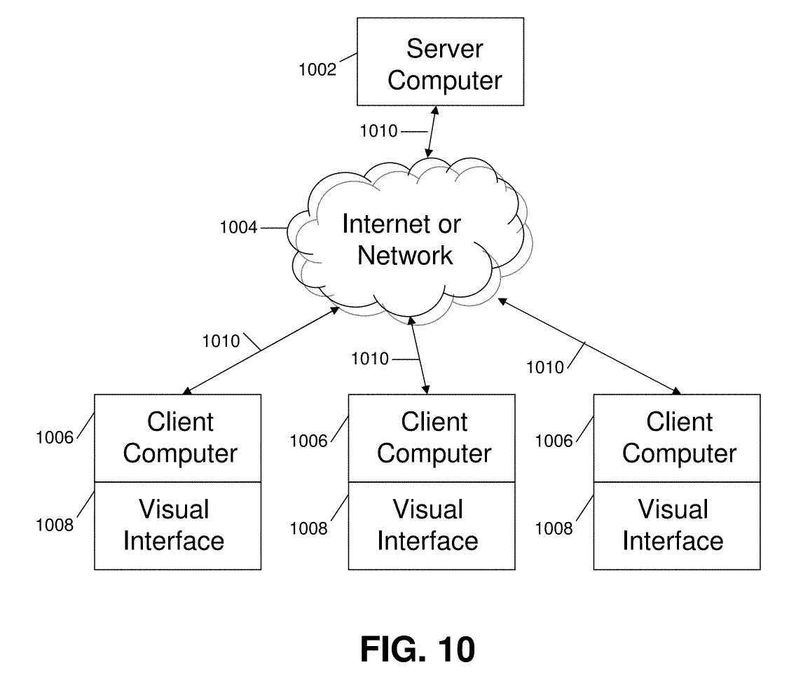

### FIG. 10—Network Architecture (Prior Art)

This figure shows prior art where multiple client computers communicate with the same server over a communications network. In some embodiments, visual interfaces (1008) can manage visual outlines on a client computer (1006), while an underlying data outline is synchronized with a shared server (1002).

1002—Server computer: It provides an authoritative copy each data outline.
1004—Communications network (e.g. internet or intranet)
1006—Client computer: It maintains a copy of the data outline for each client, and provides the visual interface (1008) with the means to interact with the data.
1008—Visual interface: The visual interface provides a way for a human to see and interact with the outline, such as a monitor, keyboard and mouse.
1010—Network connection: Like an Ethernet cable or wireless channel.

1. A method for managing multiple text outline interfaces that incorporate multi-line text editing, the method comprising:
providing two or more outlines within a visual interface generated by a digital computer, wherein each outline contains a nested list of visual nodes and each visual node can contain text;
providing a cursor that can be positioned before or after a text character in a visual node in an outline;
providing a means for editing the text within the cursor's node, where the means is similar to existing text editors;
responding to an enter keystroke by splitting the cursor's data node into two adjacent data nodes, wherein the text before the cursor remains in the original node, and the text after the cursor is moved to the newly created node;
providing a node handle within each visual node, wherein dragging and dropping the node handle between different outlines adds a link to the dragged node at the dropped location.

2. The method of claim 1, further comprising responding to a backspace keystroke by merging the cursor node's text with its preceding node if the cursor is at the beginning of its node's text.

3. The method of claim 1 wherein the source and destination outlines are different viewports of the same data outline.

4. The method of claim 1 wherein the created link is displayed like a text hyperlink inside the node at the drop location.

5. The method of claim 1 wherein the created link is presented as a docked link, which is displayed like a node in the outline containing text content that mirrors the dragged node which created the docked link.

6. The method of claim 1 wherein multiple devices are each displaying visual outlines where each visual outline shares the same data outline, and each change to the data outline on one device is synchronized to the other devices.

7. A method for reusing visual space in an outline interface that incorporates multi-line text editing, the method comprising:
providing a visual outline within a visual interface generated by a digital computer, wherein the outline contains a nested list of visual nodes and each node can contain text;
providing a cursor that can be positioned before or after a text character in a visual node in the outline;
providing a means for editing the text within the cursor's node, where the means is similar to existing text editors;
responding to an enter keystroke by splitting the cursor's node into two adjacent nodes, where the text before the cursor remains in the first node, and the text after the cursor is moved to the newly created node;
providing a node handle within each visual node, wherein:
dragging the handle can move the visual node to a different position in the outline;
pressing on the handle as a button modifies the display of the outline, but preserves its text content, hierarchy and sequence.

8. The method of claim 7, wherein pressing on a node handle toggles the visibility of the pressed node's children in the visual outline.

9. The method of claim 7, wherein pressing on a node handle hoists the outline to display only the nodes descended from the pressed node.

10. The method of claim 8, wherein pressing on a node twice in rapid succession hoists the outline to display only the nodes descended from the pressed node.

11. The method of claim 7, further comprising responding to a backspace keystroke by merging the cursor node's text with its preceding node if the cursor is at the beginning of its node's text.

12. The method of claim 7, where in some contexts, dragging the handle can instead create a link to the dragged node at the drop location.

13. The method of claim 7 wherein multiple devices are each displaying the visual outline and where the outlines all share the same data outline, and each change to the data outline on one device is synchronized to the other devices.

14. A method for contextual notification when editable outline content contains related or potentially redundant content, the method comprising:
providing a visual outline within a visual interface generated by a digital computer, wherein the outline contains a nested list of visual nodes and each node can contain text;
providing a means for editing the text content of the outline;
displaying an unobtrusive notification into this interface when the visual outline's text content has strong similarities with outline content stored elsewhere;
providing a link in the notification that permits easy access to the matching content.

15. The method of claim 14, wherein the detection of similar outline content relies primarily on the subset of the visual outline that is currently visible to the user.

16. The method of claim 14, wherein the visual interface also supports text searches, and the notification is displayed in the same area of the interface that initiates text searches.

17. The method of claim 14, wherein the notification can be displayed in several different formats, depending on how strong the closest match is.

18. The method of claim 14, wherein the search is performed on a remote server which searches for matches between the visible outline and content not available on the user's device.

19. A method for listing links that reference a particular node within a text outline, the method comprising:
providing a visual outline within a visual interface generated by a digital computer, wherein the outline contains a nested list of visual nodes and each node can contain text;
providing a means for each node to contain links to other nodes;
providing a button within each visual node wherein:
the button is only available if there are links pointing to the button's node; and
when pressed, the button displays a list of links to the nodes that contain a link to the button's node.

20. The method of claim 19, wherein the button's display includes the number of links in the list.
